(19) United States
(12) Patent Application Publication
(10) Pub. No.: US 2008/0004201 A1
(43) Pub. Date: Jan. 3, 2008

(54) Enzyme stabilizer

(76) Inventors: Jean-Pol Boutique, Gembloux (BE); Andre Cesar Baeck, Bonheiden (BE); Nathalie Jean Marie-Louise Vanwyngaerden, Leuven (BE); Jonathan Richard Stonehouse, Surrey (GB); Yonas Gizaw, Cincinnati, OH (US); Timothy Michael Rothgeb, Cincinnati, OH (US)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(21) Appl. No.: 11/810,281

(22) Filed: Jun. 5, 2007

Related U.S. Application Data
(60) Provisional application No. 60/810,910, filed on Jun. 5, 2006.

(51) Int. Cl. C11D 7/42

(52) U.S. Cl. 510/393

(57) ABSTRACT

The present invention is directed to water soluble or dispersible enzyme stabilizers as methods of using and compositions containing the same.

### CROSS REFERENCE TO RELATED APPLICATION

This application claims the benefit of U.S. Provisional Application Ser. No. 60/810,910, filed Jun. 5, 2006.

### FIELD OF THE INVENTION

The present invention is directed to water soluble or dispersible enzyme stabilizers as well as methods of using and compositions containing the same.

### BACKGROUND OF THE INVENTION

Amylase containing liquid compositions are well-known, especially in the context of laundry washing. A commonly encountered problem in such amylase containing liquid compositions is the degradation phenomenon of amylase enzyme itself, e.g. during the shelf-life of the liquid detergent composition as a consequence of the unilateral or concerted negative impact of other detergent ingredients such as e.g. surfactants, polymers, builders, chelants, etc. As a result, the stability of the amylase in the liquid composition is negatively affected and the composition consequently performs less well.

In response to this problem, it has been proposed to use various amylase inhibitors or stabilizers. Most solutions involve the addition of calcium ions to stabilize the amylase. However, the addition of calcium to liquid laundry detergents creates its own problems and presents additional new issues. For example, the inclusion of soap in liquid detergent is very economical as it can act both as a builder and as a surfactant. Addition of calcium ions can induce the undesirable precipitation of calcium soaps, especially in liquid detergent formulations with little or no organic solvent upon storage at low temperature. The addition of calcium ions is also inefficient for amylase stabilization in liquid detergent formulations comprising strong calcium sequestrants, which can scavenge the calcium ions and prevent them from exerting their amylase stabilizing effect.

Thus the need remains for an amylase stabilizer which is economical, effective and suitable for use in a liquid composition, such as, a liquid laundry composition.

### SUMMARY OF THE INVENTION

One aspect of the present invention relates to liquid detergent composition comprising:

(a) a surfactant;

(b) an amylase enzyme;

(c) a water soluble or dispersible enzyme stabilizer comprising a substituted or unsubstituted, branched or linear, polysaccharide comprising one of:
(i) a terminal group comprising at least about three α-1,4 linked substituted or unsubstituted glucose monomers;
(ii) anhydroglucose monomers;
(iii) terminal anhydroglucose monomers; or
(iv) any combination of (i), (ii) or (iii); and

(d) an adjunct ingredient.

Another aspect of the invention relates to a method of stabilizing enzymes in a liquid detergent composition, wherein the liquid detergent composition comprises one or more amylase enzymes, the method comprising at least the step of adding a stabilizing effective amount of an enzyme stabilization system to the liquid detergent composition, wherein the enzyme stabilization system comprises a water soluble or dispersible enzyme stabilizer comprising a water soluble or dispersible enzyme stabilizer comprising a substituted or unsubstituted, branched or linear, polysaccharide comprising at least one of:
(i) a terminal group comprising at least about three α-1,4 linked substituted or unsubstituted glucose monomers;
(ii) anhydroglucose monomers;
(iii) terminal anhydroglucose monomers; or
(iv) any combination of (i), (ii) or (iii).

### DETAILED DESCRIPTION OF THE INVENTION

Definitions—As used herein, “liquid detergent composition” refers to any laundry treatment composition which are not in solid (i.e., tablet or granule) or gas form. Examples of liquid laundry detergent compositions include heavy-duty liquid laundry detergents for use in the wash cycle of automatic washing-machines, liquid finewash and liquid color care detergents such as those suitable for washing delicate garments, e.g., those made of silk or wool, either by hand or in the wash cycle of automatic washing-machines. The corresponding compositions having flowable yet stiffer consistency, known as gels, are likewise encompassed. As are shear thinning liquids or gels. Other liquid or gel-form laundry treatment compositions encompassed herein include dilutable concentrates of the foregoing compositions, unit dose, spray, pretreatment (including stiff gel stick) and rinse laundry treatment compositions, or other packaged forms of such compositions, for example those sold in single or dual-compartment bottles, tubs, or polyvinyl alcohol sachets and the like. The compositions herein suitably have a sufficiently fluid rheology that they may be dosed either by the consumer, or by automated dosing systems controlled by domestic or commercial laundry appliances. Stiff gel forms may be used as pretreaters or boosters, see for example US20040102346A1, or may be dispensed in automatic dispensing systems, for example through being dissolved in-situ in the presence of a stream of water.

Enzyme Stabilizer—In one embodiment, the liquid detergent compositions comprise a water soluble or dispersible enzyme stabilizer comprising a water soluble or dispersible enzyme stabilizer comprising a substituted or unsubstituted, branched or linear, polysaccharide comprising one of:
(i) a terminal group comprising at least about three α-1,4 linked substituted or unsubstituted glucose monomers;
(ii) anhydroglucose monomers;
(iii) terminal anhydroglucose monomers; or
(iv) any combination of (i) (ii), or (iii).

In one embodiment, the enzyme stabilizer is a mixture of various different substituted or unsubstituted, branched or linear polysaccharides. This difference may be in any physical and or chemical property, such as for example, molecular weight, degree of branching, nature and location of branching, number of saccharide monomers present, type and location of saccharide monomers present, type nature and location of any anhydroglucose, presence and type of reducing sugars and the like and combinations thereof. In another embodiment, the enzyme stabilizer is a mixture of substantially similar substituted or unsubstituted, branched or linear polysaccharides.

A used herein “terminal” means the monomer or group of monomers present on an end or terminal portion of a polysaccharide. All polysaccharides as described herein have at least two terminal portions, with unsubstituted linear polysaccharides having two terminal portions, substituted linear polysaccharides having at least two terminal portions, and substituted or unsubstituted, branched polysaccharides having at least three terminal portions.

In one embodiment, the enzyme stabilizer is a homo or hetero polysaccharide, such as, a polysaccharide comprising only α linkages or bonds between the saccharide monomers. By α linkages between the saccharide monomers it is understood to have its conventional meaning, that is the linkages between the saccharide monomers are of the a anomer. For example, Formula I, the disaccharide (+) maltose or 4-O-(α-D-glucopyranosyl)-D-glucopyranose, illustrates an α linkage or bond, specifically α-1,4 linked monomers.

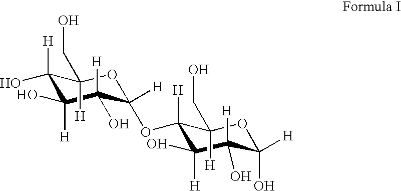

Similarly, the disaccharide (+)-cellobiose or 4-O-(β-D-Glucopyranosyl)-D-glucopyranose, as seen below in Formula II, comprises two sugars which are β-1,4 linked.

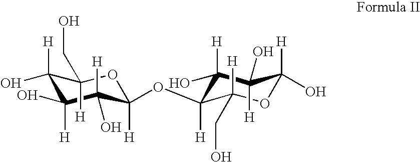

In another embodiment, the enzyme stabilizer is a homo or hetero polysaccharide, typically a polysaccharide comprising only glucose monomers, or a polysaccharide comprising only glucose monomers wherein a majority of the glucose monomers are linked by α-1,4 bonds. Glucose is an aldohexose or a monosaccharide containing six carbon atoms. It is also a reducing sugar. By “reducing sugars” it is understood to have its conventional meaning, namely a reducing sugar is a carbohydrate that reduces Fehling's solution (an alkaline solution of cupric ion complexed with tartrate ion) or Tollens' reagent (A clear solution containing Ag(NH₃)²⁺). Illustrative examples of reducing sugars are all monosaccharides, i.e., glucose, arabinose, mannose, etc, most disaccharides, i.e., maltose, cellobiose and lactose. Glucose has the structure:

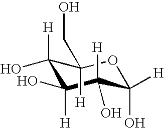

In another embodiment, the enzyme stabilizer is a homo or hetero polysaccharide, typically the enzyme stabilizer is a polysaccharide comprising only glucose monomers. In another embodiment the polysaccharide comprises only glucose monomers wherein from about 1% to about less than about 50%, of the glucose monomers are linked by non-α-1,4 bonds. In other words from about 1% to about less than about 50%, of the glucose monomers are linked by non-α-1,4 bonds, such as for example, via α-1,3 bonds α-2,4 bonds, α-1,5 bonds, α-1,6 bonds, β-1,4 bonds, β-1,6 bonds, β-1,5 bonds, β-2,4 bonds and the like. In other words, from about 1% to about less than about 50%, of the glucose monomers are linked by any bonds other than a α-1,4 bond.

In one embodiment, when the polysaccharide comprises only substituted or unsubstituted glucose monomers, the ratio of α-1,4 linked monomers to α-1,6 linked monomers is less than about 25:1, specifically less than about 20:1, more specifically is less than about 15:1.

In another embodiment, the ratio of the total number of α-1,6 linked monomers and α-1,4 linked monomers to the number of reducing sugars present within the polysaccharide is greater than or equal to about 10:1, specifically greater than or equal to about 20:1, more specifically greater than or equal to about 30:1, even more specifically greater than or equal to about 40:1. As used herein “within the polysaccharide” means any reducing sugars which are part of the polysaccharide, such as part of the polymeric backbone, forming a branch from the polymeric backbone, a substituent attached to the polymeric backbone or the like and combinations thereof.

An illustration of a α-1,4 bond between two glucose monomers can be seen in Formula I. An illustration of a α-1,6 bond between two glucose monomers can be seen in Formula III.

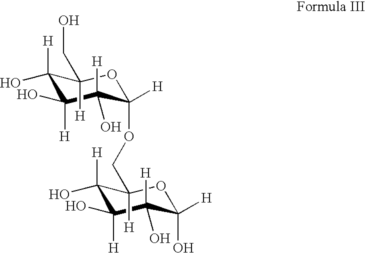

In one embodiment, the mole % of anhydroglucose monomers relative to the total number α-1,6 linked monomers and α-1,4 linked monomers is greater than about 0.5%, more specifically greater than about 1%, even more specifically is greater than about 2%. An anhydroglucose monomer is a glucose monomer which contains two rings, for example the 3, and 6 hydroxyl groups could link to form a second ring at the 3, 6 position, namely 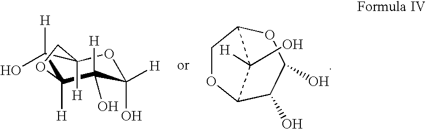
When the anhydroglucose monomer is a 3, 6 anhydroglucose such as illustrated above, the 1, and 4 positions are still available to link to other glucose monomers, meaning that they may be terminal groups of the polysaccharide or part of the backbone. However, there are anhydroglucose monomers which are terminal groups, that is, they are found at an end of the polysaccharide. Examples of these would be 1, 4 anhydroglucose which is joined to the polysaccharide via the 6 position, namely 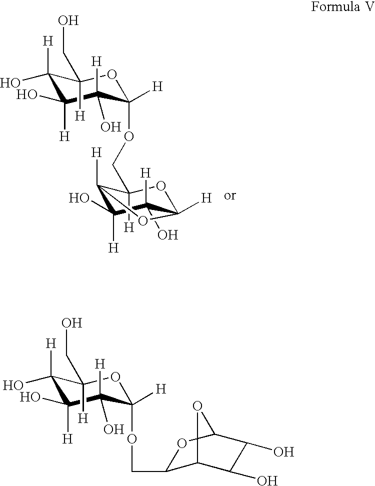
It can be seen that the glucose monomer may be connected to the polysaccharide chain via any suitable location such as the 1, 4 or 6 position. Alternatively the anhydroglucose could be the 1, 6 anhydroglucose, in which case the polysaccharide chain would be attached via the 4 position. The structure of the 1, 6 anhydroglucose can be seen below in Formula VI.

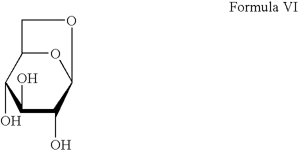

The number of α-1,4, α-1,6, α-1,3, α-2,6 bonds can be determined by examining the ¹H NMR spectra (Also know as proton NMR) of any particular enzyme stabilizer. It is to be understood that the number of bonds, e.g. α-1,4 bonds, is equivalent to the number of monomers liked by the same specific bond, i.e. the number of α-1,4, bonds is equivalent or equal to the number of monomers linked by α-1,4, bonds. The term The ¹H NMR spectra of any particular enzyme stabilizer can also be used to determine the ratio of α-1,4, linked monomers to α-1,6 linked monomers, the ratio of the total number of α-1,4 and α-1,6 linked monomers to the number of reducing sugar rings, and the mole % of anhydroglucose relative to the total number of α-1,4 and α-1,6 linked monomers.

The (1-4)/(1-6) ratio and glycosidic/reducing ratio can be readily determined. One illustrative way of determining these two ratios would be by using the method taught in Carbohydrate research. 139 (1985), 85-93. The NMR method for (1-4)/(1-6) ratio and glycosidic/reducing ratio is standard and can be referenced to Carbohydrate research. 139 (1985), 85-93.

For example the ¹H NMR spectra of various commercially available enzyme stabilizers provides the following information

| | | | Ratio of total number |
|---|---|---|---|
| | | Ratio of | of α-1,4 |
| | | α-1,4 | linked monomers and |
| | | linked | α-1,6 linked |
| | | monomers to | monomers to total |
| | Mole % of | α-1,6 | number of reducing |
| Enzyme | anhydro- | linked | sugars present within |
| Stabilizer* | glucose | monomers | the polysaccharide |
| Tackidex | 2.9 | 8.3 | 24.2 |
| C174 | | | |
| TACKIDEX | 4.9 | 8.7 | 36.6 |
| C169 | | | |
| TACKIDEX | 0.9 | 22.2 | 47.3 |
| C161 | | | |
| TACKIDEX | 3.5 | 7.6 | 44.1 |
| C070 | | | |
| TACKIDEX | 1.1 | 17.5 | 13.5 |
| B167 | | | |
| TACKIDEX | 0.9 | 18.5 | 20.5 |
| B056 | | | |
| GLUCIDEX | 0.0 | 25.2 | 14.0 |
| 9 | | | |
| TACKIDEX | 0.2 | 30.1 | 14.1 |
| B147 | | | |
| TACKIDEX | 1.9 | 10.0 | 20.0 |
| C172 | | | |
| GLUCIDEX | 0.0 | 28.8 | 5.7 |
| 21 | | | |

*All of these enzyme stabilizers are available from Roquette Frères 62080 Lestrem, France.

Additionally a close examination of the ¹H NMR spectra can identify which anhydroglucose are present, for example the ¹H NMR spectra of TACKIDEX C161 shows this anhydroglucose to be highly likely to be either a (1-6) or a (3-6) internally linked (anhydro) 6 membered sugar ring.

The presence and amount of anhydroglucose can also be determined via 1H NMR in the following fashion. A 1 H NMR is performed on an enzyme stabilizer and spectra generated examined for a signal at about 4.75 ppm which is characteristic of anhydroglucose (the signal generated by the hydrogen in the 5 position). Then the spectra are checked for a signal at about 5.5 ppm which is also characteristic of anhydroglucose (the signal generated by the hydrogen in the 1 position). These two signals should have the same relative intensity since they both come from the same sugar ring. If these two signals are not detected in the spectra generated then there is no anhydroglucose present in the enzyme stabilizer. However, if both of these signals are detected then a selective Total Correlation Spectroscopy (or Selective TOCSY) experiment is performed on the enzyme stabilizer to confirm the presence of anhydroglucose. The Selective TOCSY experiment is performed with a variety of mixing times (between 50 milliseconds and 150 milliseconds) so that the 1H NMR signals from protons which are part of the same sugar-ring can be revealed even if their signals are masked by other signals in the standard proton NMR spectra. In this way the shapes of the signals can be examined and the magnitudes of the proton spin-spin couplings associated with the protons can be assessed. Very small couplings (less than 2-3 Hz) between H1-H2, H2-H3, H3-H4, H4-H5 will confirm these signals are from protons in an anhydroglucose unit. Additional information on Selective TOCSY can be found in J. Magn. Reson. 70, 106 (1986)/J. Am. Chem. Soc 117, 4199-4200 (1995)).

While not wishing to be limited by theory, it is believed that the enzyme stabilizer acts as a substrate for the amylase, hence occupies the substrate binding cleft/active sites of the enzymes and as such prevents conformational changes which otherwise could lead to inactivation of the amylase. Upon dilution of the liquid composition in the washing liquor, the amylase-stabilizer complex dissociates and the amylase is then available to perform its desired function in the wash, i.e. hydrolysis of amylolytic substrates present on fabrics, in soils, stains, etc.

While not wishing to be limited by theory, it is believed that polysaccharides with low branching (e.g. high α1,4/α1,6 ratio) are gradually hydrolyzed by amylases upon ageing in the liquid composition, at a rate increasing with temperature, generating in-situ, oligosaccharides, some of which may help the stabilization process by inhibiting the amylase activity.

While not wishing to be limited by theory, it is believed that the hydrolysis of the more branched polysaccharides is less complete as the α-1,4 specific amylases cannot overcome the branching points (e.g. α-1,6). The in-situ formed branched polysaccharides and/or oligosaccharides seem even more suitable to inhibit the amylase activity.

Similarly, while not wishing to be limited by theory it is believed that the presence of anhydroglucose in the polysaccharide also limits the hydrolysis of the stabilizer.

In one embodiment, the enzyme stabilizer is a dextrin, typically a dextrin selected from white dextrins, yellow dextrins, maltodextrins, glucose syrups and combinations thereof. These dextrins all differ in their physical and chemical properties in many ways, such as, degree of depolymerization from the original starting polysaccharide, degree and extent of branching, degree of linearity, amount and type of reducing sugars present, amount and type of anhydroglucose present and the like and combinations thereof. For example, the maltodextrins and glucose syrups have a high α1,4/α1,6 ratio, typically above 20, that is they are substantially linear, with the maltodextrins having less depolymerization than found in the glucose syrups, whereas the white dextrins have some but a low level of branching, and the yellow dextrins are the most branched. This difference in physical and chemical properties is believed, while not wishing to be limited by theory, to be due to the process by which these various dextrins are manufactured. For example the maltotodextrins & glucose syrups which are white in color (e.g. the GLUCIDEX series of dextrins commercially available from Roquette) are subjected to acid hydrolysis substantially at room temperature and only subjected to higher temperature during the spray drying process step (a temperature of around 70° C.). While not wishing to be limited by theory, this process is believed to lead to limited depolymerization, and to limited additional branching. The white dextrins, which are off white in color (e.g. the TACKIDEX B series commercially available from Roquette) by contrast, are obtained by acid hydrolysis at temperature no more than 150° C., which while not wishing to be limited by theory, is believed to lead to limited depolymerization, additional branching and limited formation of anhydroglucoses but more than occurs in the production of maltotodextrins & glucose syrups. Lastly, yellow dextrins, which are off white to yellow-brown in color (e.g. the TACKIDEX C series commercially available from Roquette) are obtained by acid hydrolysis at high temperature (i.e. process temperatures greater than about 175° C.), at which they undergo a series of condensation/transglycosylation reactions making them more branched and giving them a yellow/brownish color. This higher temperature acid hydrolysis, while not wishing to be limited by theory, is believed to lead to limited depolymerization, and formation of some anhydroglucoses more than occurs in the production of white dextrins. The maltotodextrins & glucose syrups are made by a process that relies on a high concentration of acid and lower temperature, which leads to more linear, if not substantially linear product.

White dextrins, yellow dextrins, maltodextrins and glucose syrups are available form a variety of sources. Illustrative examples of commercially available maltodextrins and glucose syrups include: the GLUCIDEX series of products available form Roquette, such as GLUCIDEX 1, GLUCIDEX 6D, GLUCIDEX 9, GLUCIDEX 12D, GLUCIDEX 17D, GLUCIDEX 19D, GLUCIDEX 21D, GLUCIDEX 28E, GLUCIDEX 29D, GLUCIDEX 32D, GLUCIDEX 39, GLUCIDEX 40, and GLUCIDEX 47; C* Dry GL available from Cargill; Dextrin from Corn available from Sigma Chemicals. Illustrative examples of commercially available white dextrins include: TACKIDEX B series from Roquette, such as, TACKIDEX B039, TACKIDEX B056, TACKIDEX B147, and TACKIDEX B167. Illustrative examples of commercially available yellow dextrins include: TACKIDEX C series from Roquette, such as, TACKIDEX C161, Tackldex C058, Tackldex C062, TACKIDEX C070, TACKIDEX C169, and TACKIDEX C174.

In one embodiment, it the liquid cleaning composition comprises no more than about 0.1%, by weight of the composition, of calcium and/or magnesium ions; and less than about 5%, by weight of the composition, of organic polyol solvent.

In another embodiment, the liquid cleaning composition is substantially free of amines. By “substantially free” of amines it is meant that specifically no amines are purposefully added to the formulation, but yet it is understood to one of ordinary skill in the art that trace amounts of amines may be present as impurities in other additives, i.e. the composition contains less than about 0.1%, by weight of the composition of amines. While not wanting to be limited by theory, it is believed that any amines present may react with some of the saccharides present, thereby resulting in a color change either over time or instantly of the liquid laundry detergent. While in some circumstances such as color change of the liquid laundry detergent is not desired, in others such a change is.

In one embodiment, the use of a polysaccharide in a liquid detergent composition is also within the scope of the present invention. This surprisingly and hitherto unexpected degree and nature of branching and/or presence, degree and nature of anhydroglucoses provides a material which is specifically useful in liquid detergent composition, more specifically usefully for stabilization of any amylase enzymes contained therein.

These previously unsuspected and unappreciated properties of the polysaccharides described herein can be characterized in a use of a polysaccharide in a liquid detergent composition one of several ways, namely: (1) in that the ratio of α-1,4 linked monomers to α-1,6 linked monomers is less than about 25:1, more specifically less than about 20:1, even more specifically is less than about 15:1; (2) in that the ratio of the total number of α-1,6 linked monomers and α-1,4 linked monomers to the number of reducing sugars is greater than or equal to about 10:1, specifically greater than or equal to about 20:1, more specifically greater than or equal to about 30:1, even more specifically greater than or equal to about 40:1; (3) in that the mole % of anhydroglucose monomers relative to the total number of α-1,6 linked monomers and α-1,4 linked monomers is greater than about 0.5%, more specifically greater than about 1%, even more specifically is greater than about 2%; or (4) any possible combination of (1), (2) or (3).

In one embodiment, the composition comprises, from about 0.01% to about 5%, specifically from about 0.1% to about 1.5%, more specifically from about 0.2% to about 1%, by weight of the composition, of the enzyme stabilizer.

Surfactants—In one embodiment the liquid detergent composition of the present invention may contain one or more surface active agents (surfactants). The surfactant may be selected from anionic, nonionic, cationic, amphoteric, zwitterionic and mixtures thereof. In one embodiment, surfactant detergents for use in the present invention are mixtures of anionic and nonionic surfactants although it is to be understood that any surfactant may be used alone or in combination with any other surfactant or surfactants. When present in the concentrated detergent composition, the surfactant may comprise from about 0.1% to about 70%, more specifically from about 1% to about 50%, by weight of the liquid detergent composition.

Illustrative examples of surfactants useful herein are described in U.S. Pat. No. 3,664,961, U.S. Pat. No. 3,919,678, U.S. Pat. No. 4,062,647, U.S. Pat. No. 4,316,812 U.S. Pat. No. 3,630,929, U.S. Pat. No. 4,222,905, U.S. Pat. No. 4,239,659, U.S. Pat. No. 4,497,718; U.S. Pat. No. 4,285,841, U.S. Pat. No. 4,284,532, U.S. Pat. No. 3,919,678, U.S. Pat. No. 2,220,099 and U.S. Pat. No. 2,477,383. Surfactants generally are well known, being described in more detail in Kirk Othmer's Encyclopedia of Chemical Technology, 3rd Ed., Vol. 22, pp. 360-379, “Surfactants and Detersive Systems”, McCutcheon's, Detergents & Emulsifiers, by M.C. Publishing Co., (North American edition 1997), Schwartz, et al., Surface Active Agents, Their Chemistry and Technology, New York: Interscience Publishers, 1949; and further information and examples are given in “Surface Active Agents and Detergents” (Vol. I and II by Schwartz, Perry and Berch).

Nonionic surfactant, when present in the liquid detergent composition may be present in the amount of from about 0.01% to about 70%, more specifically from about 1% to about 50%, even more specifically from about 5% to about 40%, by weight of the liquid detergent composition. Illustrative examples of suitable nonionic surfactants include: alcohol ethoxylates (e.g. Neodol 25-9 from Shell Chemical Co.), alkyl phenol ethoxylates (e.g. Tergitol NP-9 from Union Carbide Corp.), alkylpolyglucosides (e.g. Glucapon 600CS from Henkel Corp. ), polyoxyethylenated polyoxypropylene glycols (e.g. Pluronic L-65 from BASF Corp.), sorbitol esters (e.g. Emsorb 2515 from Henkel Corp.), polyoxyethylenated sorbitol esters (e.g. Emsorb 6900 from Henkel Corp.), alkanolamides (e.g. Alkamide DC212/SE from Rhone-Poulenc Co.), and N-alkypyrrolidones (e.g. Surfadone LP-100 from ISP Technologies Inc.); and combinations thereof.

Anionic surfactant, when present in the liquid detergent composition may be present in the amount of from about 0.01% to about 70%, more specifically from about 1% to about 50%, even more specifically from about 5% to about 40%, by weight of the liquid detergent composition. Illustrative examples of suitable anionic surfactants includes: linear alkyl benzene sulfonates (e.g. Vista C-500 commercially available from Vista Chemical Co.), branched linear alkyl benzene sulfonates (e.g. MLAS), alkyl sulfates (e.g. Polystep B-5 commercially available from Stepan Co.), branched alkyl sulfates, polyoxyethylenated alkyl sulfates (e.g. Standapol ES-3 commercially available from Stepan Co.), alpha olefin sulfonates (e.g. Witconate AOS commercially available from Witco Corp.), alpha sulfo methyl esters (e.g. Alpha-Step MCp-48 commercially available from Stepan Co.) and isethionates (e.g. Jordapon Cl commercially available from PPG Industries Inc.), and combinations thereof.

Cationic surfactant, when present in the liquid detergent composition, may be present in the amount of from about 0.01% to about 70%, more specifically from about 1% to about 50%, even more specifically from about 5% to about 40%, by weight of the liquid detergent composition. Specific cationic surfactants include C8-C 18 alkyl dimethyl ammonium halides and analogs in which one or two hydroxyethyl moieties replace one or two methyl moieties.

Amphoteric surfactant, when present in the liquid detergent composition may be present in the amount of from about 0.01% to about 70%, more specifically from about 1% to about 50%, even more specifically from about 5% to about 40%, by weight of the liquid detergent composition. Examples of amphoteric surfactants are sodium 3(dodecylamino)propionate, sodium 3-(dodecylamino)propane-1-sulfonate, sodium 2-(dodecylamino)ethyl sulfate, sodium 2-(dimethylamino) octadecanoate, disodium 3-(N-carboxymethyldodecylamino)propane 1-sulfonate, disodium octadecyl-imminodiacetate, sodium 1-carboxymethyl-2-undecylimidazole, and sodium N,N-bis(2-hydroxyethyl)-2-sulfato-3-dodecoxypropylamine.

Zwitterionic surfactant, when present in the liquid detergent composition may be present in the amount of from about 0.01% to about 70%, more specifically from about 1% to about 50%, even more specifically from about 5% to about 40%, by weight of the liquid detergent composition.

Amylase Enzyme—The compositions and methods of the present invention comprise one or more amylase enzymes. In one embodiment, the compositions herein includes an amylase enzyme from about 0.00001% to about 2%, specifically from about 0.00005% to about 1%, more specifically from about 0.0001% to about 0.1%, even more specifically from about 0.0002% to about 0.02%, by weight of the detergent composition, of an amylase enzyme.

Any amylase suitable for use in detergents can be used. Such amylase can be of animal, vegetable or microbial origin, with both modified (chemical or genetically variants) and unmodified amylase included. In one embodiment, the amylase enzyme is an α-amylase, more specifically a E.C.3.2.1.1 hydrolase, even more specifically a E.C.3.2.1.1 hydrolase produced from bacterial sources, even more specifically still a E.C.3.2.1.1 hydrolase produced from bacterial sources selected from B. licheniformis, B. subtilis, B. amyloliquefaciens, B. stearothernophilus, Bacillus strains deposited as NCIB 12289, NCIB 12512, NCIB 12513, DSM 9375, KSM-K36, KSM-K38, KSM-AP1378, their variants and mixtures thereof.

A non-limiting list of suitable commercially available amylase enzymes include: Amylases (α and/or β) described in WO 94/02597 and WO 96/23873,and the Termamyl-like amylase, such as the Termamyl-like amylase having at least a 65% identity with the AA sequence of the Termamyl amylase, disclosed in U.S. Patent Application Publication No. 2003/0129718. Commercial examples of amylase enzymes include Purastar and Purastar OxAm® [Genencor] and Termamyl®, Termamyl Ultra®, Stainzyme®, Natalase®, Ban®, Fungamyl® and Duramyl® [all ex Novozymes] and combinations thereof.

Adjunct Ingredients—The compositions and methods of the present invention may include an adjunct ingredient, specifically from about 0.00001% to about 95%, more specifically from about 0.001% to about 70%, by weight of the detergent composition, of an adjunct ingredient.

In one embodiment of the instant invention, the adjunct ingredient may be selected from builders, brightener, dye transfer inhibitor, chelants, polyacrylate polymers, dispersing agents, colorant dye, hueing dyes, perfumes, processing aids, bleaching additives, bleach activators, bleach precursors, bleach catalysts, solvents, co-solvents, hydrotropes, liquid carrier, phase stabilizers, soil release polymers, enzyme stabilizers, enzymes, soil suspending agents, anti-redeposition agents, deflocculating polymers, bactericides, fungicides, UV absorbers, anti-yellowing agents, anti-oxidants, optical brighteners, suds suppressors, opacifiers, suds boosters, anticorrosion agents, radical scavengers, chlorine scavengers, structurants, fabric softening additives, other fabric care benefit agents, pH adjusting agents, fluorescent whitening agents, smectite clays, structuring agents, preservatives, thickeners, coloring agents, fabric softening additives, rheology modifiers, fillers, germicides and mixtures thereof. Further examples of suitable adjunct ingredient and levels of use are described in U.S. Pat. No. 3,936,537; U.S. Pat. No. 4,285,841, U.S. Pat. No. 4,844,824, U.S. Pat. No. 4,663,071, U.S. Pat. No. 4,909,953, U.S. Pat. No. 3,933,672, U.S. Pat. No. 4,136,045, U.S. Pat. No. 2,379,942, U.S. Pat. No. 3,308,067, U.S. Pat. No. 5,147,576, British Patent 1,470,250, British Patent 401,413, British Patent 461,221, British Patent No. 1,429,143, and U.S. Pat. No. 4,762,645.

Nonlimiting examples of some of possible adjunct ingredients follows.

Suitable chelants include ethylenediamine tetraacetic acid (EDTA), Diethylenetriaminepentaacetate (DTPA), 1-Hydroxyethylidene 1,1 diphosphonic acid (HEDP), Diethylenetriamine-penta-methylene phosphonic acid (DTPMP), dipicolinic acid and salts and/or acids thereof and mixtures thereof. Further examples of suitable chelating agents and levels of use are described in U.S. Pat. Nos. 3,812,044; 4,704,233; 5,292,446; 5,445,747; 5,531,915; 5,545,352; 5,576,282; 5,641,739; 5,703,031; 5,705,464; 5,710,115; 5,710,115; 5,712,242; 5,721,205; 5,728,671; 5,747,440; 5,780,419; 5,879,409; 5,929,010; 5,929,018; 5,958,866; 5,965,514; 5,972,038; 6,172,021; and 6,503,876.

Examples of suitable builders which may be used include water-soluble alkali metal phosphates, polyphosphates, borates, silicates and also carbonates; water-soluble amino polycarboxylates; fatty acid soaps; water-soluble salts of phytic acid; polycarboxylates; zeolites or aluminosilicates and combinations thereof. Specific examples of these are: sodium and potassium triphosphates, pyrophosphates, orthophosphates, hexametaphosphates, tetraborates, silicates, and carbonates; water-soluble salts of mellitic acid, citric acid, and carboxymethyloxysuccinic acid, salts of polymers of itaconic acid and maleic acid, tartrate monosuccinate, tartrate disuccinate; and mixtures thereof.

In one embodiment, the liquid detergent composition may contain more than about 0.1%, by weight of the composition, of a calcium sequestrant having a conditional stability constant at pH 8 is higher than about 4. The calcium sequestrant with a conditional stability constant at pH 8 is higher than about 4 is able to form soluble complexes with Ca ions. In one embodiment, the calcium sequestrant is selected from selected from 1-Hydroxy Ethylidene 1,1 Di Phosphonic acid (HEDP), Di Ethylene Triamine Penta Acetic acid (DTPA), nitrilotriacetic acid (NTA) and combinations thereof.

While not wanting to be limited by theory, it is believed that amylases like Natalase complex calcium ions, for instance, amylases like Natalase are able to complex calcium ions with a dissociation constant of 3.92. See. p. 79, of WO 96/2387.

In presence of strong calcium sequestrants like HEDP, the calcium sequestrant removes the calcium ions from the amylase, leading to destabilization of the enzyme. Weak calcium sequestrants, i.e. a stability constant at pH 8 lower than about 4, like citrate do no extract calcium from the enzyme to the same extent. As a result, the presence of weak calcium sequestrants has no or only little impact on amylase stability leading to the destabilization of the enzyme. Additional information on calcium sequestrants and their stability constants can be found in “Keys to Chelation with Versene Chelating Agents” published by the Dow Company see tables 4.4, 4.5, 4.6, 4.7.”, and Monsanto Technical Bulletin 53-39(E) ME-2.

Another optional adjunct ingredient is a thickener. Illustrative examples of thickeners include rheology modifiers, structurants and combinations thereof. Illustrative examples of structurants useful herein include methylcellulose, hydroxypropylmethylcellulose such as Methocel® trade name from Dow Chemical, xanthan gum, gellan gum, guar gum and hydroxypropyl guar gum, succinoglycan and trihydroxystearin. Other illustrative examples of structurants include the nonpolymeric hydroxyfunctional structurants, such as, castor oil and its derivatives. Commercially available, castor oil-based, crystalline, hydroxyl-containing structurants include THIXCIN ® from Rheox, Inc. See also U.S. Pat. No. 6,080,708 and WO 02/40627. Another commercially available structurant is 1,4-di-O-benzyl-D-threitol in the R,R, and S,S forms and any mixtures, optically active or not.

The detergent compositions herein may also optionally contain low levels of materials which serve as phase stabilizers and/or co-solvents for the liquid compositions herein. Materials of this type include C₁-C₃ lower alkanols such as methanol, ethanol and/or propanol. Lower C₁-C₃ alkanolamines such as mono-, di- and triethanolamines can also be used, by themselves or in combination with the lower alkanols. If present, phase stabilizers/co-solvents can optionally comprise from about 0.1% to 5.0% by weight of the compositions herein.

Non Amylase Enzyme—The compositions and methods described herein may include a non-amylase enzyme, specifically from about 0.00001% to about 2%, more specifically from about 0.0005% to about 1%, even more specifically from about 0.001% to about 0.5%, by weight of the detergent composition, of a non-amylase enzyme.

Examples of suitable non-amylase enzymes include, but are not limited to, hemicellulases, peroxidases, cellulases, xylanases, lipases, phospholipases, esterases, cutinases, pectinases, pectate lyases, keratanases, reductases, oxidases, phenoloxidases, lipoxygenases, ligninases, pullulanases, tannases, pentosanases, malanases, β-glucanases, mannanases, arabinosidases, hyaluronidase, chondroitinase, laccase, protease and combinations thereof. Other types of enzymes may also be included. They may be of any suitable origin, such as vegetable, animal, bacterial, fungal and yeast origin. However, their choice is governed by several factors such as pH-activity and/or stability optima, thermostability, stability versus active detergents, builders and so on.

A potential enzyme combination—in addition to amylase—comprises a mixture of conventional detersive enzymes selected from cellulases, lipases, proteases, mannanases, pectate lyases and mixtures thereof. Detersive enzymes are described in greater detail in U.S. Pat. Nos. 6,579,839, 6,060,299 and 5,030,378; European Patent Nos. 251,446 and 130,756; and WO01/02530, WO91/06637, WO95/10591, WO99/20726, WO99/27083. WO96/33267, WO99/02663 and WO 95/26393.

In one embodiment, optional additional enzyme stabilizers may be included. These optional additional enzyme stabilizers would be those known enzyme stabilizers other than the water dispersible enzyme stabilizer described herein herein. Illustrative examples of these additional optional enzyme stabilizers include any known stabilizer system like calcium and/or magnesium compounds, boric acid derivatives (i.e. boric acid, boric oxide, borax, alkali metal borates, such as sodium ortho-, meta- and pyroborate and sodium pentaborate and mixtures thereof), low molecular weight carboxylates, relatively hydrophobic organic compounds (i.e., certain esters, diakyl glycol ethers, alcohols or alcohol alkoxylates), alkyl ether carboxylate in addition to a calcium ion source, benzamidine hypochlorite, lower aliphatic alcohols and carboxylic acids, N,N-bis(carboxymethyl) serine salts; (meth)acrylic acid-(meth)acrylic acid ester copolymer and PEG; lignin compounds, polyamide oligomer, glycolic acid or its salts; poly hexa methylene bi guanide or N,N-bis-3-amino-propyl-dodecyl amine or salt; and mixtures thereof. See also U.S. Pat. No. 3,600,319, EP 0 199 405 and U.S. Pat. No. 3,519,570.

In one embodiment, the liquid detergent compositions and methods may also optionally comprise a reversible peptide protease inhibitor of the formula:

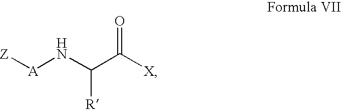

In the reversible peptide protease inhibitor, A is an amino acid moiety, typically composed of one or more amino acids.

In Formula VII, Z is a N-capping moiety selected from: 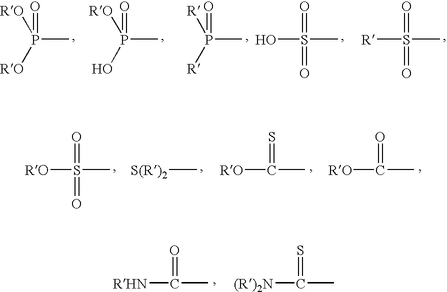
and mixtures thereof.

R′ is independently selected from linear or branched, substituted or unsubstituted C₁-C₆ alkyl; phenyl; linear or branched, substituted or unsubstituted C₇-C₉ alkylaryl; linear or branched substituted or unsubstituted C₄-C₈ cycloalkyl moieties; and mixtures thereof.

Nonlimiting illustrative examples of suitable reversible peptide protease inhibitors include: 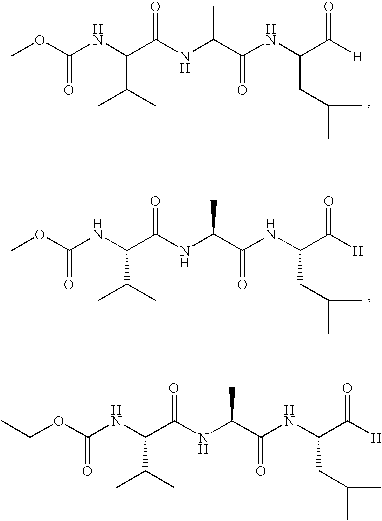
and mixtures thereof.

The reversible peptide protease inhibitor may be made in any suitable manner. Illustrative examples of suitable process for the manufacture of the reversible peptide protease inhibitor may be found in U.S. Pat. No. 6,165,966.

In one embodiment, the composition comprises from about 0.00001% to about 5%, specifically from about 0.00001% to about 3%, more specifically from about 0.00001% to about 1%, by weight of the composition, of the reversible peptide protease inhibitors.

In one embodiment, the liquid detergent composition may comprise a reversible aromatic protease inhibitor of the formula: 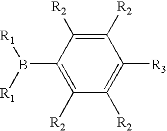
It is important to note that the B in the reversible aromatic protease inhibitor formula represents the element Boron and not a markush group. Each R₁ is independently selected from, hydroxy; linear or branched, substituted or unsubstituted C₁-C₆ alkoxy; each R₂ is independently selected from hydrogen; hydroxyl; linear or branched, substituted or unsubstituted C₁-C₆ alkyl; linear or branched, substituted or unsubstituted C₁-C₆ alkoxy; linear or branched, substituted or unsubstituted C₁-C₆ alkenyl; and mixtures thereof; and R₃ is selected from hydrogen; hydroxyl; linear or branched, substituted or unsubstituted C₁-C₆ alkyl; linear or branched, substituted or unsubstituted C₁-C₆ alkoxy; linear or branched, substituted or unsubstituted C₁-C₆ alkenyl; C(O)—R₄ and mixtures thereof.

Nonlimiting illustrative examples of suitable reversible aromatic protease inhibitors include:

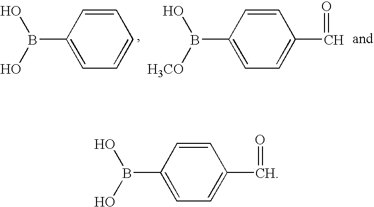

In one embodiment, the composition comprises, from about 0.00001% to about 5%, specifically from about 0.00001% to about 2%, by weight of the composition, of the reversible aromatic protease inhibitors.

Additional information on reversible peptide protease inhibitor and reversible aromatic protease inhibitors may also be found in copending U.S. Provisional Patent Application No. 60/810,912 entitled “Enzyme Stabilization” filed on May 06, 2006 in the name of J. P. Boutique, et. al., Attorney Docket Number 10425P and in copending U.S. Provisional Patent Application No. 60/810,909, entitled “Enzyme Stabilization” filed on May 06, 2006 in the name of J. P. Boutique, et. al., Attorney Docket Number 10426P.

In another embodiment, the compositions and methods of the present invention, may comprise less than about 5%, by weight of the detergent composition, specifically less than about 3%, by weight of the detergent composition, more specifically less than about 1%, by weight of the detergent composition, even more specifically is substantially free of boric acid derivatives. By “substantially free of boric acid derivatives” it is meant that more specifically no boric acid derivatives are purposefully added to the formulation, but yet it is understood to one of ordinary skill in the art that trace amounts of boric acid derivatives may be present as impurities or as process/stability in other additives, i.e. the composition contain less than about 0.1%, by weight of the composition of boric acid derivatives.

By “boric acid derivatives” it is meant boron containing compounds such as boric acid per se, substituted boric acids and other boric acid derivatives that at least a part of which are present in solution as boric acid or a chemical equivalent thereof, such as a substituted boric acid. Illustrative, but non-limiting examples of boric acid derivatives includes, boric acid, boric oxide, borax, alkali metal borates (such as sodium ortho-, meta- and pyroborate and sodium pentaborate), and mixtures thereof.

In one embodiment, the liquid detergent composition and methods of the present invention may comprise less than about 5%, by weight of the detergent composition, specifically less than about 3%, by weight of the detergent composition, more specifically still less than about 1% by weight of the detergent composition, even more specifically is substantially free of organic polyol solvents. By “substantially free of organic polyol solvents” it is meant that more specifically no organic polyol solvents are purposefully added to the formulation, but yet it is understood to one of ordinary skill in the art that trace amounts of organic polyol solvents may be present as impurities or as process/stability aids in other additives, i.e. the composition contain less than about 0.1%, by weight of the composition of organic polyol solvents.

By “organic polyol solvents”, it is meant low molecular weight organic solvents composed of carbon, oxygen and hydrogen atoms, and comprising 2 or more hydroxyl groups, such as ethanediol, 1,2 and 1,3 propanediol, glycerol, glycols and glycolethers, sorbitol, mannitol, 1,2 benzenediol, and mixtures thereof. This definition especially encompasses the diols, especially the vicinal diols that are capable of forming complexes with boric acid and borate to form borate esters.

Liquid Carrier—The liquid cleaning compositions according to the present invention may also contain a liquid carrier. Typically the amount of the liquid carrier when present in the compositions herein will be relatively large, often comprising the balance of the cleaning composition, but can comprise from about 5 wt % to about 85 wt % by weight of the cleaning composition. In one embodiment low levels, 5% to 20% by weight of the cleaning composition of liquid carrier is utilized.

In another embodiment, the compositions may comprise at least about 60%, more specifically at least about 65%, even more specifically at least about 70%, even more still at least about 75%, by weight of the cleaning composition of liquid carrier.

The most cost effective type of aqueous, non-surface active liquid carrier is, of course, water itself. In one embodiment, the water when present is selected from distilled, deionized, filtered and combinations thereof. In another embodiment, of the water may be untreated.

Liquid Detergent Composition Formulation—Liquid detergent compositions can be prepared by admixing the essential and optional ingredients thereof in any desired order to provide compositions containing components in the requisite concentrations. Liquid compositions according to the present invention can also be in “compact form”, in such case, the liquid detergent compositions according to the present invention will contain a lower amount of water, compared to conventional liquid detergents.

The liquid detergent compositions of the present invention may be of any desired color or appearance, namely opaque, translucent, or transparent, such as the compositions of U.S. Pat. No. 6,630,437. For purposes of the invention, as long as one wavelength in the visible light range has greater than 25% transmittance, it is considered to be transparent or translucent.

The compositions according to the present invention may have any suitable pH, specifically a pH of from about 5.5 to about 11, more specifically from about 6 to about 9, even more specifically from about pH from about 6 to about 8.5. The composition pH is measured as a neat solution at standard temperature and pressure, i.e. 21° C., and at 1 atmosphere pressure.

Detergent Packaging—The detergent compositions according to the present invention may be presented to the consumer in standard packaging, or may be presented in any suitable packaging. Recently, multiple compartment bottles containing multiple formulations that are dispensed and combined have become used for detergent compositions. The compositions of the present invention may be formulated for inclusion in such packages. In addition, unit dose packages have also become commonly used for detergent compositions. Such packages are also suitable for use with the compositions of the present invention.

The packaging may be of any desired color or appearance, namely opaque, translucent or transparent, or even combinations thereof. Illustrative but non-limiting packages may be found in U.S. Pat. No. 6,630,437.

Methods of Use—The present invention also provides a method for cleaning fabrics. Such a method employs contacting these fabrics with an aqueous washing solution formed from an effective amount of the liquid detergent compositions hereinbefore described. Contacting of fabrics with washing solution will generally occur under conditions of agitation.

In one embodiment, the invention provides a method of stabilizing enzymes in a liquid detergent composition, more specifically heavy duty detergent composition, wherein said liquid detergent composition comprises one or more amylase enzymes, more specifically one or more amylase enzymes and one or more non-amylase enzymes, said method comprising at least the step of adding a stabilizing effective amount of an enzyme stabilization system to said liquid detergent composition, wherein said enzyme stabilization system comprises a water soluble or dispersible enzyme stabilizer comprising a substituted or unsubstituted, branched or linear polysaccharide comprising at lease about three α-1,4 linked substituted or unsubstituted glucose monomers as a terminal group.

Agitation is preferably provided in a washing machine for good cleaning. Washing 5 is preferably followed by drying the wet fabric e.g. line-drying or in a conventional clothes dryer. An effective amount of the liquid detergent composition in the aqueous wash solution in the washing machine may be specifically from about 500 to about 10,000 ppm, more specifically from about 2,000 to about 10,000 ppm, under typical European washing conditions and may be specifically from about 1,000 to about 3,000 ppm under 10 typical U.S.A. washing conditions. In the newer high efficiency (HE) washing machines in the U.S.A., higher product concentrations are delivered to fabric and therefore soil and dye-loads in the wash solution are even higher. Product concentration and raw material levels are thereby adjusted to accommodate these changes in wash conditions due to washing machine changes.

### EXAMPLES

The following liquid detergent compositions in table 1 are prepared and put in storage for 3 weeks at 30° C. The stability of the amylases is then determined. Example A prepared according to the invention shows significantly improved amylase stability vs. comparative example 3. Examples B and C show comparable or even improved amylase stability vs. both comparative examples 1 and 2.

TABLE 1

| | Comparative | | | |
|---|---|---|---|---|
| | Example 1 | A | B | C |
| C₁₁₋₁₂ linear alkyl benzene sulfonate | 8 | 8 | 8 | 8 |
| C₁₄₋₁₅ ethoxylated (EO₈) alcohol | 6 | 6 | 6 | 6 |
| C₁₂₋₁₄ dimethyl Amine Oxide | 1 | 1 | 1 | 1 |
| C₁₂₋₁₈ Fatty Acid | 5 | 5 | 5 | 5 |
| Citric Acid | 2 | 2 | 2 | 2 |
| Diethylene triamine penta | 0.2 | 0.2 | 0.2 | 0.2 |
| methylenephosphonic acid | | | | |
| Ethoxysulfated hexamethylene | 0.8 | 0.8 | 0.8 | 0.8 |
| diamine quat¹ | | | | |
| Ethoxylated Polyethyleneimine² | 0.2 | 0.2 | 0.2 | 0.2 |
| Ethoxylated tetraethylene pentamine³ | 0.2 | 0.2 | 0.2 | 0.2 |
| Ethanol | 1.4 | 1.4 | 1.4 | 1.4 |
| 1,2-Propanediol | 2.4 | 2.4 | 2.4 | 2.4 |
| Di Ethylene Glycol | 1.6 | 1.6 | 1.6 | 1.6 |
| Na Cumene Sulfonate | 0.7 | 0.7 | 0.7 | 0.7 |
| Monoethanolamine | 0.5 | 0.5 | 0.5 | 0.5 |
| Protease⁴ (40 mg/g) | 0.46 | 0.46 | 0.46 | 0.46 |
| Termamyl^{R} 300L (Novozymes) | 0.05 | 0.05 | 0.05 | 0.05 |
| Natalase^{R} 200L (Novozymes) | 0.07 | 0.07 | 0.07 | 0.07 |
| Mannanase^{R} 25L (Novozymes) | 0.04 | 0.04 | 0.04 | 0.04 |
| Reversible Protease Inhibitor⁵ | 0.002 | 0.002 | 0.002 | 0.002 |
| Boric acid | — | — | — | — |
| TACKIDEX B039 (Roquette) | — | 0.5 | — | — |
| TACKIDEX C161 (Roquette) | — | — | 0.5 | — |
| TACKIDEX C169 (Roquette) | — | — | — | 0.5 |
| Hydrogenated castor oil structurant | 0.2 | 0.2 | 0.2 | 0.2 |
| Sufficient Sodium hydroxide to pH | 8.2 | 8.2 | 8.2 | 8.2 |
| Water + Minors (perfume, etc) | Quantity | q.s. | q.s. | q.s. |
| | Sufficient | to | to | to |
| | (q.s.) to | 100% | 100% | 100% |
| | 100% | | | |
| Amylase stability (% left after | 18% | 44% | 53% | 59% |
| 3 weeks at 30° C.) | | | | |

¹Lutensit Z from BASF
²Lutensol FP620 from BASF
³Lutensol PG105K from BASF
⁴Protease “B” see EP 251446.
⁵Reversible Protease inhibitor of structure

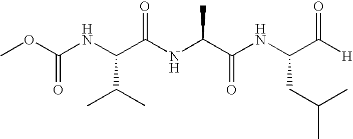

The amylase stability can be determined via the use of a SMT kit available from Merck. The SMT kit comprises a 2-Chloro-4-nitrophenyl-B,D-maltoheptaoside. The amylase in the product matrix acts on the 2-Chloro-4-nitrophenyl-B,D-maltoheptaoside to cleave the alpha glucose linkages. The resulting chromophore linked maltosides (2-3 glucose units only) are then further broken down by α-glucosidase to 2-Chloro-4-nitrophenyl-B,D-glucoside. α-Glucosidase then acts on the beta glucosidic linkage between the chromophore and the glucose unit producing 2-Chloro-4-nitrophenol and Glucose. The increase in absorbance (405 nm) over time, facilitated by the release of Cl-PNP by the β-glucosidase, is directly proportional to the amylase activity in the matrix.

Additional liquid detergent compositions illustrating the invention are given in Tables 2-4.

TABLE 2

| | D | E | F | G | H | I | J | K |
|---|---|---|---|---|---|---|---|---|
| C₁₁₋₁₂ linear | 8 | 8 | 8 | 8 | 8 | 8 | 8 | 5 |
| alkyl benzene | | | | | | | | |
| sulfonate | | | | | | | | |
| C₁₄₋₁₅ ethoxy- | 6 | 6 | 6 | 6 | 6 | 6 | 6 | 4 |
| lated (EO₈) | | | | | | | | |
| alcohol | | | | | | | | |
| C₁₂₋₁₄ dimethyl | 1 | 1 | 1 | 1 | 1 | 1 | 1 | — |
| Amine Oxide | | | | | | | | |
| C₁₂₋₁₈ Fatty | 3 | 3 | 3 | 3 | 3 | 3 | 3 | 4 |
| Acid | | | | | | | | |
| Citric Acid | 3 | 3 | 3 | 3 | 3 | 3 | 3 | 1 |
| Diethylene | 0.2 | 0.2 | 0.2 | 0.2 | 0.2 | 0.2 | 0.2 | — |
| triamine penta | | | | | | | | |
| methylene- | | | | | | | | |
| phosphonic | | | | | | | | |
| acid | | | | | | | | |
| Ethoxysulfated | 1.2 | 1.2 | 1.2 | 1.2 | 1.2 | 1.2 | 1.2 | 1 |
| hexamethylene | | | | | | | | |
| diamine quat¹ | | | | | | | | |
| 1-Hydroxy | — | — | — | — | — | — | — | 0.6 |
| Ethylidene 1,1 | | | | | | | | |
| Di Phosphonic | | | | | | | | |
| acid | | | | | | | | |
| Ethoxylated | — | — | — | — | — | — | — | 0.5 |
| Polyethylene- | | | | | | | | |
| imine² | | | | | | | | |
| Ethanol | — | — | — | — | — | — | 1.4 | 0.2 |
| 1,2- | — | — | — | — | — | — | 3.5 | 0.6 |
| Propanediol | | | | | | | | |
| Di Ethylene | — | — | — | — | — | — | 1.6 | — |
| Glycol | | | | | | | | |
| Na Cumene | — | — | — | — | — | — | 0.7 | — |
| Sulfonate | | | | | | | | |
| Mono Ethanol | — | — | — | — | — | — | 0.5 | — |
| Amine | | | | | | | | |
| Potassium | — | — | — | — | — | — | 0.15 | — |
| sulfite | | | | | | | | |
| Protease³ | 0.46 | 0.46 | 0.46 | 0.46 | 0.46 | 0.46 | 0.46 | 0.7 |
| (40 mg/g) | | | | | | | | |
| Termamyl^{R} | 0.05 | 0.05 | 0.05 | 0.05 | 0.05 | 0.05 | 0.05 | — |
| 300L | | | | | | | | |
| (Novozymes) | | | | | | | | |
| Natalase^{R} | 0.07 | 0.07 | 0.07 | 0.07 | 0.07 | 0.07 | 0.07 | 0.20 |
| 200L | | | | | | | | |
| (Novozymes) | | | | | | | | |
| Mannanase^{R} | 0.04 | 0.04 | 0.04 | 0.04 | 0.04 | — | 0.04 | 0.05 |
| 25L | | | | | | | | |
| (Novozymes) | | | | | | | | |
| Pectawash^{R} | — | — | — | — | — | — | 0.10 | 0.1 |
| 20L | | | | | | | | |
| (Novozymes) | | | | | | | | |
| Carezyme^{R} 5L | — | 0.01 | — | — | — | — | — | — |
| (Novozymes) | | | | | | | | |
| Reversible | 0.002 | 0.002 | — | 0.001 | 0.002 | — | 0.002 | 0.010 |
| Protease | | | | | | | | |
| Inhibitor⁴ | | | | | | | | |
| Formic acid | — | — | 1 | — | — | 1 | — | — |
| Boric acid | — | — | 1 | — | — | — | — | — |
| TACKIDEX | 0.5 | 1.5 | 0.5 | 1 | — | — | 0.75 | 1 |
| C161 | | | | | | | | |
| (Roquette) | | | | | | | | |
| Gialla C*Plus | — | — | — | — | 0.5 | — | — | — |
| 08381 (Cargill) | | | | | | | | |
| TACKIDEX | — | — | — | — | — | 0.5 | — | — |
| C166 | | | | | | | | |
| (Roquette) | | | | | | | | |
| Hydrogenated | 0.3 | 0.3 | 0.3 | 0.3 | 0.3 | | 0.3 | 0.3 |
| castor oil | | | | | | | | |
| structurant | | | | | | | | |
| Sufficient | 8.3 | 8.3 | 8.3 | 8.3 | 8.3 | 8.2 | 8.2 | 8.2 |
| Sodium | | | | | | | | |
| hydroxide | | | | | | | | |
| to pH | | | | | | | | |
| Water + | q.s. | q.s. | q.s. | q.s. | q.s. | q.s. | q.s. | q.s. |
| Minors | to | to | to | to | to | to | to | to |
| (perfume, etc) | 100% | 100% | 100% | 100% | 100% | 100% | 100% | 100% |

¹Lutensit Z from BASF
²Lutensol FP620 from BASF
³Protease “B” see EP 251446.
⁴Reversible Protease inhibitor of structure

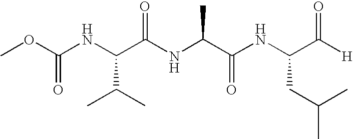

TABLE 3

| | L | M | N | O |
|---|---|---|---|---|
| C₁₁₋₁₂ linear alkyl benzene sulfonic acid | 8 | 12 | 12 | 0.2 |
| C₁₄₋₁₅ ethoxylated (EO₈) alcohol | 5 | 8 | 7 | 11 |
| C12 Alkyl Poly Glucoside | — | — | 1 | — |
| C₁₂₋₁₄ dimethyl Amine Oxide | 1 | — | — | 3 |
| C₁₂₋₁₈ Fatty Acid | 2.6 | 4 | 4 | — |
| Citric Acid | 2.6 | 4 | 4 | 3 |
| Diethylene triamine penta methylene- | 0.2 | 0.3 | 0.3 | 0.3 |
| phosphonic acid | | | | |
| Ethoxysulfated hexamethylene diamine quat¹ | 1.2 | 2 | 2 | 2 |
| Ethanol | 1.4 | 1.4 | 1.4 | 0.4 |
| 1,2-Propanediol | 2.4 | 2.4 | 2.4 | 3 |
| Diethylene glycol | 1.6 | 1.6 | 1.6 | — |
| 2-methyl-1,3-Propanediol | 1 | 1 | 1 | — |
| Na Cumene Sulfonate | 0.7 | 2 | 2 | — |
| Sodium formate | 0.5 | — | — | — |
| Monoethanolamine | 0.5 | 1 | — | — |
| Potassium sulfite | — | 0.10 | — | — |
| Potease² (40 mg/g) | — | 0.72 | — | 0.46 |
| Savinase^{R} 16L (Novozymes) | 0.5 | — | 0.8 | — |
| Alcalase^{R} 2.5L (Novozymes) | — | 0.6 | — | — |
| Termamyl^{R} 300L (Novozymes) | 0.05 | 0.07 | 0.07 | — |
| Natalase^{R} 200L (Novozymes) | 0.07 | 0.10 | 0.10 | 0.14 |
| Mannanase^{R} 25L (Novozymes) | 0.04 | 0.06 | 0.06 | — |
| Pectawash^{R} 20L (Novozymes) | 0.10 | 0.17 | — | — |
| Carezyme^{R} 5L (Novozymes) | 0.002 | — | — | — |
| Boric acid | 0.5 | 1 | — | — |
| Reversible Protease Inhibitor³ | 0.002 | 0.002 | 0.004 | 0.002 |
| TACKIDEX C161 (Roquette) | 0.5 | 0.3 | 0.5 | 0.4 |
| CaCl2 | — | — | 0.01 | — |
| Hydrogenated castor oil structurant | 0.2 | 0.4 | 0.4 | 0.5 |
| Cationic silicone⁴ | — | — | — | 1 |
| Sufficient Sodium hydroxide to pH | 8.2 | 8.2 | 8.2 | 8.2 |
| Water + Minors (perfume, etc) | q.s. | q.s. | q.s. | q.s. |
| | to | to | to | to |
| | 100% | 100% | 100% | 100% |

¹Lutensit Z from BASF
²Protease “B” see EP 251446.
³Reversible Protease inhibitor of structure

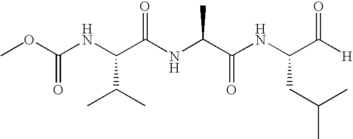

⁴Cationic silicone as per WO 2002/18528 A1

TABLE 4

| | P | Q | R | S | T |
|---|---|---|---|---|---|
| C₁₁₋₁₂ linear alkyl benzene sulfonic | 6 | — | 8 | 1.5 | — |
| acid | | | | | |
| C₁₂₋₁₅ alkyl ethoxy (EO_{1.8}) sulfate Na | 12 | 18 | 3 | 7 | — |
| salt | | | | | |
| C₁₆₋₁₈ Alkyl Sulfate Na salt | — | — | — | — | 0.3 |
| C₁₂₋₁₄ ethoxylated (EO₇) alcohol | — | — | 10 | — | — |
| C₁₂₋₁₃ ethoxylated (EO₉) alcohol | 1 | 0.5 | — | 4 | 14 |
| C12-14 Alkyl Poly Glycoside | — | — | — | — | 1 |
| C₁₂₋₁₄ Dimethyl Amine Oxide | 1 | — | — | — | — |
| C12 Tri Methyl Ammonium Chloride | — | 2.5 | — | — | |
| Di C16-18 alkyl ethoxymethyl | — | — | — | — | 1.6 |
| ammonium methosulfate | | | | | |
| C₁₂₋₁₈ Fatty Acid | 2 | 2.5 | 8 | 2.5 | 0.5 |
| Citric Acid | 3.5 | 2.5 | — | 2.5 | — |
| Diethylene triamine penta | — | — | — | 0.2 | — |
| methylenephosphonic acid | | | | | |
| Diethylene triamine penta acetate | 0.1 | — | — | — | — |
| MW = 393 | | | | | |
| Ethoxysulfated hexamethylene | 1 | 0.5 | — | 0.2 | — |
| diamine quat¹ | | | | | |
| Ethoxylated Polyethyleneimine² | 1 | 0.5 | — | — | — |
| Ethoxylated tetraethylene pentamine³ | 0.5 | 0.3 | — | — | — |
| Ethanol | 2 | 3 | — | 1 | 0.5 |
| 1,2-Propanediol | 7 | 5 | 4 | — | — |
| Sorbitol | — | — | 5 | — | 0.3 |
| Na Cumene Sulfonate | — | 3 | — | — | — |
| Borax | 0.5 | 0.3 | — | — | — |
| Sodium silicate | — | — | 2 | — | — |
| Sodium formate | 0.15 | 0.03 | — | — | — |
| Monoethanolamine | — | 1 | — | — | — |
| Triethanolamine | — | — | 1 | — | — |
| Potassium sulfite | — | 0.2 | — | — | — |
| Protease⁴ (40 mg/g) | 1 | 0.35 | 0.5 | 0.5 | — |
| Termamyl^{R} 300L (Novozymes) | — | — | 0.06 | 0.05 | — |
| Natalase^{R} 200L (Novozymes) | 0.3 | 0.10 | — | — | 0.10 |
| Mannanase^{R} 25L (Novozymes) | 0.05 | — | — | — | — |
| Polymer LR400⁵ | — | — | 0.3 | — | — |
| Reversible Protease Inhibitor⁶ | 0.001 | 0.002 | 0.002 | 0.004 | — |
| Aromatic Protease Inhibitor⁷ | 0.2 | — | — | — | — |
| TACKIDEX C161 (Roquette) | 0.5 | 0.5 | 0.4 | 0.5 | 0.4 |
| CaCl2 | 0.01 | — | — | — | — |
| Preservative | — | — | 0.01 | — | — |
| Hydrogenated castor oil structurant | — | — | — | 0.3 | — |
| Poly Vinyl Pyridine N-oxide MW | — | — | — | 0.1 | — |
| 13 kDa | | | | | |
| Polymer LR400⁷ | — | — | — | 0.2 | — |
| Sufficient Sodium hydroxide to pH | 8.0 | 8.2 | 8.0 | 8.0 | 6.5 |
| Water + Minors (perfume, etc) | q.s. | q.s. | q.s. | q.s. | q.s. |
| | to | to | to | to | to |
| | 100% | 100% | 100% | 100% | 100% |

¹Lutensit Z from BASF
²Lutensol FP620 from BASF
³Lutensol PG105K from BASF.
⁴Protease “B” see EP 251446.
⁵Cationic cellulose polymer available from Amerchol
⁶Reversible Protease inhibitor of structure

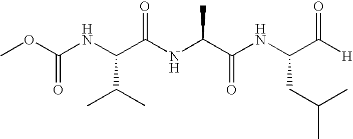

⁷Aromatic protease inhibitor of structure

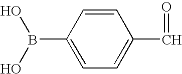

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

The compositions of the present invention can include, consist essentially of, or consist of, the components of the present invention as well as other ingredients described herein. As used herein, “consisting essentially of” means that the composition or component may include additional ingredients, but only if the additional ingredients do not materially alter the basic and novel characteristics of the claimed compositions or methods.

All percentages stated herein are by weight unless otherwise specified. It should be understood that every maximum numerical limitation given throughout this specification will include every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein. All temperatures are in degrees Celsius (° C.) unless otherwise specified.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A liquid detergent composition comprising:
(a) a surfactant;
(b) an amylase enzyme;
(c) a water soluble or dispersible enzyme stabilizer comprising a substituted or unsubstituted, branched or linear, polysaccharide comprising one of:
(i) a terminal group comprising at least about three α-1,4 linked substituted or unsubstituted glucose monomers;
(ii) anhydroglucose monomers;
(iii) terminal anhydroglucose monomers; or
(iv) any combination of (i), (ii) or (iii);
(d) an adjunct ingredient.

2. The liquid detergent according to claim 1 wherein said enzyme stabilizer is a homo or hetero polysaccharide.

3. The liquid detergent according to claim 2 wherein said enzyme stabilizer is a polysaccharide comprising only α linkages between the saccharide monomers.

4. The liquid detergent according to claim 2 wherein said enzyme stabilizer is a polysaccharide comprising only glucose monomers.

5. The liquid detergent according to claim 4 wherein a majority of the glucose monomers are linked by α-1,4 linked monomers.

6. A liquid detergent composition according to claim 4 wherein from about 1% to about less than about 50%, of the glucose monomers are linked by non-α-1,4 linked monomers.

7. A liquid detergent composition according to claim 5 wherein the ratio of the number of α-1,4 linked monomers to the number of α-1,6 linked monomers is less than about 25:1.

8. A liquid detergent composition according to claim 5 wherein the ratio of the total number of α-1,6 linked monomers and α-1,4 linked monomers to the number of reducing sugars present within said polysaccharide is greater than or equal to about 10:1.

9. A liquid detergent composition according to claim 5 wherein the mole % of anhydroglucose monomers relative to the total number of α-1,6 linked monomers and α-1,4 linked monomers is greater than about 0.5%.

10. A liquid detergent composition according to claim 5 wherein said enzyme stabilizer comprises at least two of the following:
(1) in that the ratio of the number of α-1,4 linked monomers to α-1,6 linked monomers is less than about 25:1;
(2) in that the ratio of the total number of α-1,6 linked monomers and α-1,4 linked monomers to the number of reducing sugars present within said polysaccharide is greater than or equal to about 10: 1; and
(3) in that the mole % of anhydroglucose monomers relative to the total number of α-1,6 linked monomers and α-1,4 linked monomers is greater than about 0.5%.

11. A liquid detergent composition according to claim 1 comprising from about 0.01% to about 5%, by weight of the composition, of the water soluble or dispersible enzyme stabilizer.

12. A liquid detergent composition according to claim 1 wherein said enzyme stabilizer is a dextrin selected from white dextrins, yellow dextrins, maltodextrins and combinations thereof.

13. A liquid detergent composition according to claim 12 wherein said enzyme stabilizer is a dextrin selected from white dextrins, yellow dextrins and combinations thereof.

14. A liquid detergent composition according to claim 1 wherein said amylase is an α-amylase.

15. A liquid detergent composition according to claim 5, wherein said liquid detergent composition comprises at least one of:
(i) less than about 5%, by weight of the composition, of boric acid derivatives;
(ii) more than about 50% water;
(iii) a thickener;
(iv) less than about 5%, by weight of the composition, of organic polyol solvents;
(v) less than about 0.1%, by weight of the composition, of calcium and/or magnesium ions;
(vi) from about 0.1% to about 5% by weight of the composition, of a calcium sequestrant having a conditional stability constant at pH 8 of greater than about 4;
(vii) substantially free of amines;
(viii) from about 0.00001% to about 2% by weight of the composition, of said amylase enzyme;
(viii) a protease;
(ix) a protease stabilizer selected from reversible peptide protease inhibitors reversible aromatic protease inhibitors and combinations thereof; or
(x) non-amylase enzyme selected from cellulases, lipases, mannanases, pectate lyases and combinations thereof.

16. A liquid detergent composition according to claim 1 wherein said adjunct ingredient is selected from adjunct ingredient is selected from builders, brighteners, dye transfer inhibitors, structurants, fabric softening additives, chelants, polyacrylate polymers, dispersing agents, dyes, perfumes, processing aids, bleaching additives, bleach activator, bleach catalyst, solvent, non-amylase enzyme, enzyme inhibitor, soil release polymers, reducing agents and mixtures thereof.

17. A method of stabilizing enzymes in a liquid detergent composition, wherein said liquid detergent composition comprises one or more amylase enzymes, said method comprising at least the step of adding a stabilizing effective amount of an enzyme stabilization system to said liquid detergent composition, wherein said enzyme stabilization system comprises a water soluble or dispersible enzyme stabilizer comprising a water soluble or dispersible enzyme stabilizer comprising a substituted or unsubstituted, branched or linear, polysaccharide comprising one of:
(i) a terminal group comprising at least about three α-1,4 linked substituted or unsubstituted glucose monomers;
(ii) anhydroglucose monomers;
(iii) terminal anhydroglucose monomers; or
(iv) any combination of (i), (ii) or (iii).

18. Use of a polysaccharide in a liquid detergent composition wherein said polysaccharide is characterized in one of the following:
(i) the ratio of α-1,4 linked monomers to α-1,6 linked monomers is less than about 25:1;
(ii) the ratio of the total number of α-1,6 linked monomers and α-1,4 linked monomers to the number of reducing sugars present within said polysaccharide is greater than or equal to about 10:1;
(iii) the mole % of anhydroglucose monomers relative to the total number of α-1,6 linked monomers and α-1,4 linked monomers is greater than about 0.5%; or
(iv) any combination of (i), (ii) or (iii).

19. Use of a liquid laundry detergent composition comprising a polysaccharide wherein said polysaccharide is characterized in that the ratio of α-1,4 linked monomers to α-1,6 linked monomers is less than about 25:1.

20. An article of commerce comprising
(a) a transparent or translucent container; and
(b) a liquid laundry detergent according to claim 1 stored in said container.
